(19) United States
(12) Patent Application Publication
(10) Pub. No.: US 2013/0066006 A1
(43) Pub. Date: Mar. 14, 2013

(54) WHITE INK JET INK FOR TEXTILE PRINTING

(71) Applicant: Yoshitaka MIYAJIMA, Matsumoto (JP)

(72) Inventor: Yoshitaka MIYAJIMA, Matsumoto (JP)

(73) Assignee: SEIKO EPSON CORPORATION, Tokyo (JP)

(21) Appl. No.: 13/609,701

(22) Filed: Sep. 11, 2012

(30) Foreign Application Priority Data
Sep. 13, 2011 (JP) 2011-199128

(51) Int. Cl. C09D 11/10

(52) U.S. Cl. 524/497

(57) ABSTRACT

A white ink jet ink for textile printing containing a white pigment and a urethane resin, in which an average particle diameter of the white pigment and an average particle diameter of the urethane resin satisfy the following formula:

2≦average particle diameter of white pigment/average particle diameter of urethane resin≦12.

The entire disclosure of Japanese Application No. 2011-199128 filed on Sep. 13, 2011 is expressly incorporated by reference herein.

### BACKGROUND

1. Technical Field

The present invention relates to white ink jet ink for textile printing.

2. Related Art

In the related art, metallic oxides such as titanium dioxide, zinc oxide, silica, alumina, magnesium oxide; barium sulfate, calcium carbonate and the like are used in various printing methods as a white pigment contained in an ink, and in particular, metallic oxides such as titanium dioxide and zinc oxide are used often from the point of being inexpensive. However, because metallic oxide pigment has a large specific gravity difference from a solvent, there is a problem in that the metallic oxide pigment easily precipitates. In particular, in a case where the particle diameter and concentration of the white pigment are increased in order to obtain high concealment and color developability, precipitation occurs even more easily. In addition, there is a problem in that the white pigment solidifies due to progression of aggregation.

As a method of solving such problems, for example, in the printing device according to JP-A-8-20119, JP-A-2003-39690, or JP-A-2006-15267, using a stirring mechanism, a circulation mechanism or the like is disclosed.

In addition, there is a problem in that in a printed textile product obtained using an ink containing a metallic oxide, sufficient color fastness to rubbing may not be obtained.

However, even in a case where a stirring mechanism or the like is used, the pigment precipitates, and there are cases where it is difficult to redisperse the aggregated and solidified white pigment.

### SUMMARY

Therefore, an advantage of some aspects of the invention is to provide a white ink jet ink for textile printing which has excellent redispersibility and in which a printed textile product which has excellent color fastness to rubbing may be obtained, even in a case where the pigment has precipitated.

In addition, another advantage of some aspects of the invention is to provide a white ink jet ink for textile printing which has excellent redispersibility and in which a printed textile product having excellent color fastness to rubbing, and degree of whiteness may be obtained, even in a case where the pigment has precipitated.

The invention was completed by a white ink jet ink for textile printing according to forms A and B.

The white ink jet ink for textile printing according to form A contains a white pigment and a urethane resin, in which an average particle diameter of the white pigment and an average particle diameter of the urethane resin satisfy the following formula.

2≦average particle diameter of white pigment/average particle diameter of urethane resin≦12

The white ink jet ink for textile printing according to form B contains titanium dioxide of an average particle diameter of from 300 nm to 400 nm and a urethane resin, in which a content of the titanium dioxide is from 5 to 15 mass % with respect to the total mass of the ink, and an average particle diameter of the titanium dioxide and an average particle diameter of the urethane resin satisfy the following formula.

2≦average particle diameter of white pigment/average particle diameter of urethane resin≦12

In other words, the invention may be realized as the aspects or application examples below.

### APPLICATION EXAMPLE 1

According to Application Example 1, there is provided a white ink jet ink for textile printing including: a white pigment; and a urethane resin, in which an average particle diameter of the white pigment and an average particle diameter of the urethane resin satisfy the following formula.

2≦average particle diameter of white pigment/average particle diameter of urethane resin≦12

According to an aspect of the invention described in Application Example 1, the average particle diameter of the white pigment and the average particle diameter of the urethane resin are controlled so as to satisfy the above formula, thereby the redispersibility of the white ink may be improved.

### APPLICATION EXAMPLE 2

In the white ink jet ink for textile printing according to Application Example 1, the white pigment is titanium dioxide of an average particle diameter of from 300 nm to 400 nm, and a content of the titanium dioxide with respect to a total mass of the ink is from 5 to 15 mass %.

According to an aspect of the invention described in Application Example 2, an ink having excellent degree of whiteness may be obtained.

### APPLICATION EXAMPLE 3

In the white ink jet ink for textile printing according to Application Example 1 or 2, the urethane resin has an acid value of from 10 to 25 mgKOH/g.

According to an aspect of the invention described in Application Example 3, excellent degree of whiteness may be obtained.

### APPLICATION EXAMPLE 4

In the white ink jet ink for textile printing according to any one of Application Examples 1 to 3, a content of the urethane resin with respect to a total mass of ink is from 5 to 10 mass %.

According to an aspect of the invention described in Application Example 4, the urethane resin acts as a binder between the white pigment and the fabric, and the degree of color fastness to rubbing of the printed product may be improved.

### APPLICATION EXAMPLE 5

The white ink jet ink for textile printing according to Application Examples 1 to 4, further including: a dispersion resin, in which a mass ratio of a content of the dispersion resin with respect to a mass of a content of the white pigment is from 3 to 30 mass %.

According to an aspect of the invention described in Application Example 5, an ink having excellent white pigment dispersion properties may be obtained, and an ink having excellent redispersibility even if the white pigment has aggregated may be obtained.

### APPLICATION EXAMPLE 6

In the white ink jet ink for textile printing according to any one of Application Examples 1 to 5, a moisture content of a total mass of ink is from 50 to 90 mass %.

According to an aspect of the invention described in Application Example 6, the dispersion properties of the white pigment may be increased.

### DESCRIPTION OF EXEMPLARY EMBODIMENTS

Below, description will be given of favorable embodiments of the invention. The embodiments described below are for describing examples of the invention. In addition, the invention is not limited by the embodiments below and also includes various modifications carried out in a range not departing from the gist of the invention.

In the present specification, the term “average particle diameter” means “the cumulative 50% average particle diameter based on volume (d50) according to the light scattering method”, and is the value obtained in the manner described below. The particles within the dispersion medium are irradiated with light and the generated diffraction scattered light is measured by using detectors positioned in front, to the sides and behind the dispersion medium. Using the measured value, the particles which are inherently irregularly shaped are assumed to be spherical, a cumulative curve, where the total volume of the particle group translated to spheres of an equal volume to the particles is 100%, is obtained, and the point at which the cumulative value becomes 50% is set to the 50% average particle diameter (d50).

In addition, in the present specification, the average particle diameter of the urethane resin means the state within the ink. Therefore, the urethane resin, in the process of the ink jet textile printing, in a state where the ink dries and adheres to a recording medium, may maintain a particle shape, and may also form a membrane.

### 1. Ink Jet Ink

The white ink jet ink for textile printing according to an aspect of the invention is a white ink jet ink for textile printing containing a white pigment and a urethane resin, and in which the average particle diameter of the white pigment and the average particle diameter of the urethane resin satisfy Formula (1) below.

2≦average particle diameter of white pigment/average particle diameter of urethane resin≦12 (1)

Below, detailed description will be given of each of the components included in the ink jet ink according to the present embodiment.

### 1.1. White Pigment

The ink jet ink according to an embodiment of the invention contains a white pigment. Examples of the white pigment include, for example, metallic oxides, barium sulfate, calcium carbonate and the like. Examples of the metallic oxide include, for example, titanium dioxide, zinc oxide, silica, alumina, magnesium oxide and the like. Among these, titanium dioxide is preferable from the viewpoint of having excellent degree of whiteness.

The average particle diameter of the white pigment is not particularly limited as long as the above formula is satisfied, however, for example, it is preferably from 300 nm to 400 nm. When the average particle diameter exceeds 400 nm, there are cases in which a reduction in reliability is brought about, such as deterioration of the discharging properties of the white ink. On the other hand, when the average particle diameter is less than 300 nm, there is a tendency for color density such as the degree of whiteness to be insufficient. In the present specification, the average particle diameter means the cumulative 50% average particle diameter based on volume, and is measured using the light scattering method. The measurement of the average particle diameter may be, for example, measured using the Microtrac UPA150 (Microtrac Inc.).

The content of the white pigment is, with respect to the total mass of the ink jet ink, preferably from 5 to 15 mass %. When the content of the white pigment exceeds 15 mass %, reliability may be impaired by clogging of the ink jet type recording head or the like. On the other hand, when the content is less than 5 mass %, there are cases in which the color density such as the degree of whiteness is insufficient.

### 1.2. Urethane Resin

The ink jet ink according to an embodiment of the invention contains a urethane resin. There are no particular limits to what may be used as the urethane resin. As the urethane resin, there are no particular limits, and aside from one with a urethane bond, a polyether urethane resin including an ether bond in the main chain thereof, a polyester urethane resin including an ester bond in the main chain thereof, a polycarbonate urethane resin including a carbonate bond in the main chain thereof, and the like may be used. Among these, polycarbonate urethane resins and polyester urethane resins may be used preferably.

The average particle diameter of the urethane resin is not particularly limited as long as the above formula is satisfied, however, for example, it is preferably from 25 nm to 180 nm. By staying within the above range, aggregation and solidification when the white ink precipitates are suppressed, an advantageous effect in that the redispersibility increase may be obtained. Meanwhile, when the average particle diameter exceeds 180 nm, there are cases in which a reduction in reliability is brought about, such as deterioration of the discharging properties of the white ink, and when the average particle diameter is less than 25 nm, there are concerns of the fixing properties of the printed product decreasing and the color fastness to rubbing being degraded. In addition, as a form of the urethane resin within the ink, there are no particular limitations, however, emulsion is preferable.

The acid value of the urethane resin is not particularly limited, however, is preferably from 10 to 25 mgKOH/g. By staying within the above range, when a fabric is printed on, strike through of the white ink is suppressed, and an advantageous effect of realizing a high color density may be obtained. When the acid value exceeds 25 mgKOH/g, the solubility of the urethane resin increases, and there are concerns that a degradation in the color fastness to rubbing will be brought about. In addition, when the acid value is less than 10 mgKOH/g, the reactivity between the urethane resin and the multivalent metal ions present in the preprocessing agent for textile printing is low, and there is a tendency for the white ink to strike through. Here, the acid value in the present specification is measured using the titration method.

Examples of the urethane resin include, a commercial product may be used, for example, SF150 (average particle diameter 70 nm), SF150HS (average particle diameter 110 nm), SF210 (average particle diameter 50 nm), SF800 (average particle diameter 30 nm), SF870 (average particle diameter 30 nm), SF460 (average particle diameter 30 nm), and SF470 (average particle diameter 50 nm) from the SUPERFLEX (SF) series manufactured by Dai-Ichi Kogyo Seiyaku Co., Ltd., WS-5000, (average particle diameter 90 nm), WS6021 (average particle diameter 70 nm), W6010 (average particle diameter 60 nm), W6020 (average particle diameter 80 nm), W6061 (average particle diameter 100 nm), and W605 (average particle diameter 80 nm) from the TAKELAC series manufactured by Mitsui Chemicals, Inc., and the like. Among these urethane resins, SF150, SF470 and the like manufactured by Dai-Ichi Kogyo Seiyaku Co., Ltd. which have a resin acid value of from 10 to 25 mgKOH/g are more preferable.

In addition, the polyurethane resin which is synthesized using a well-known method may also be used as the urethane resin. Polyols, chain extenders, polyisocyanate, and organic acids which may be used as the monomer when synthesizing will be described below.

### Polyols

Examples of the polyols include, compounds containing 2 or more hydroxyl groups, for example, straight chain aliphatic glycols such as ethylene glycol, propylene glycol, 1,3-propanediol, 1,3-butanediol, 1,4-butanediol, 1,5-pentanediol, 1,2-pentanediol, 3-methyl-1,5-pentanediol, 1,6-hexanediol, 1,2-hexanediol, diethylene glycol, triethylene glycol, tetraethylene glycol, dipropylene glycol, tripropylene glycol, polyethylene glycol, polypropylene glycol, 1,8-octanediol, 1,2-octanediol, and 1,9-nonanediol; branched aliphatic glycols such as neopentyl glycol, 3-methyl-1,5-pentanediol, 2-methyl-1,3-propanediol, 2,2-dimethyl-1,3-propanediol, 2-butyl-2-ethyl-1,3-propanediol, 2,2-dibutyl-1,3-propanediol, and 2-methyl-1,8-octanediol; alicyclic glycols such as 1,4-cyclohexanediol, and 1,4-cyclohexane dimethanol; and multifunctional glycols such as glycerin, trimethylolethane, trimethylolpropane, tributylolpropane, pentaerythritol, sorbitol; and the above may be used in isolation, or 2 or more types may be used together, and furthermore, 2 or more types may be used as a copolymer.

In addition, in an aspect of the invention, polyester polyol may also be used. For example, this may be obtained using a well-known method such as dehydration synthesizing the glycols or ethers with the divalent carboxylic acid or carboxylic acid anhydride examples of which are given below. Here, examples of the specific compound used in the production of a polyester polyol which can be used in an aspect of the invention will be given. Examples of the saturated or unsaturated glycols include various types of glycol, for example, straight chain aliphatic glycols such as ethylene glycol, propylene glycol, 1,3-propanediol, 1,3-butanediol, 1,4-butanediol, 1,5-pentanediol, 1,2-pentanediol, 3-methyl-1,5-pentanediol, 1,6-hexanediol, 1,2-hexanediol, diethylene glycol, triethylene glycol, tetraethylene glycol, dipropylene glycol, tripropylene glycol, polyethylene glycol, polypropylene glycol, 1,8-octanediol, 1,2-octanediol, and 1,9-nonanediol; branched aliphatic glycols such as neopentyl glycol, 3-methyl-1,5-pentanediol, 2-methyl-1,3-propanediol, 2,2-dimethyl-1,3-propanediol, 2-butyl-2-ethyl-1,3-propanediol, 2,2-dibutyl-1,3-propanediol, and 2-methyl-1,8-octanediol; alicyclic glycols such as 1,4-cyclohexanediol, and 1,4-cyclohexane dimethanol; and multifunctional glycols such as glycerin, trimethylolethane, trimethylolpropane, tributylolpropane, pentaerythritol, sorbitol.

In addition, examples of the ethers include, for example, alkyl glycidyl ethers such as n-butyl glycidyl ether and 2-ethylhexyl glycidyl ether, and monocarboxylic acid glycidyl esters such as versatic acid glycidyl ester.

In addition, examples of divalent carboxylic acid or acid anhydride include, for example, dibasic acids of adipic acid, maleic acid, fumaric acid, phthalic anhydride, isophthalic acid, terephthalic acid, succinic acid, oxalic acid, malonic acid, glutaric acid, pimelic acid, azelaic acid, sebacic acid, suberic acid, or the like, anhydride acids or dimer acids corresponding to these, castor oil, fatty acids thereof and the like. Other than the polyester polyols obtained by performing dehydration synthesis using the above, polyester polyols obtained by performing open ring polymerization on a cyclic ester compound may be exemplified.

As polyester polyols which may be used in an aspect of the invention, for example, a poly[(3-methyl-1,5-pentanediol)-alt-(adipic acid)] in which a 3-methyl-1,5-pentanediol and an adipic acid are dehydration synthesized (Kuraray Polyol P2010, manufactured by Kuraray Co., Ltd.) and the like are commercially available.

Furthermore, polycarbonate polyols which may be used in an aspect of the invention are generated by undergoing a reaction such as, in general, a demethylation condensation reaction between a multivalent alcohol and a dimethyl carbonate, a diphenol condensation reaction between a multivalent alcohol and a diphenyl carbonate, or a deethylene glycol condensation reaction between a multivalent alcohol and an ethylene carbonate. Examples of multivalent alcohols which are used in these reactions include, for example, various saturated or unsaturated glycols such as 1,6-hexanediol, diethylene glycol, triethylene glycol, propylene glycol, 1,3-butanediol, 1,4-butanediol, neopentyl glycol, pentanediol, 3-methyl-1,5-pentanediol, octanediol, 1,4-butynediol, dipropylene glycol, tripropylene glycol, and polytetramethylene ether glycol, and alicyclic glycols such as 1,4-cyclohexanediglycol, and 1,4-cyclohexane dimethanol.

As polycarbonate polyols which may be used in an aspect of the invention, for example, copolymers in which 1,6-hexanediol is the main component (PES-EXP815, manufactured by Nippon Polyurethane Industry Co., Ltd.) and the like are commercially available.

In addition, examples of the polytetramethylene ether glycol include, for example, a polytetramethylene ether glycol obtained by adding a tetrahydrofuran to 1 type or 2 or more types of multivalent alcohol such as ethylene glycol, diethylene glycol, propylene glycol, dipropylene glycol, glycerin, trimethylol propane, or neopentyl glycol using open ring polymerization. These cyclic ethers may be used in isolation, or 2 or more types thereof may be used together, and furthermore, a copolymer in which 2 or more types of the above cyclic ethers are used may also be used. For example, copolymers of tetrahydrofuran and neopentylglycol (PTXG-1800, manufactured by Asahi Kasei Corporation) and the like are commercially available.

Furthermore, as a polyol which may be used in an aspect of the invention, for example, ACTCOL EP3033 (manufactured by Mitsui Chemical Urethane Co., Ltd.), PREMINOL 7003 (manufactured by Asahi Glass Co., Ltd.), PREMINOL 7001 (manufactured by Asahi Glass Co., Ltd.), ADEKA POLYETHER AM302 (manufactured by Adeka Corp.) and the like are commercially available.

### Chain Extenders

In an aspect of the invention, as chain extenders, the following may be used. For example, examples of the polyol compounds containing 2 or more hydroxyl groups include, for example, straight chain aliphatic glycols such as ethylene glycol, propylene glycol, 1,3-propanediol, 1,3-butanediol, 1,4-butanediol, 1,5-pentanediol, 1,2-pentanediol, 3-methyl-1,5-pentanediol, 1,6-hexanediol, 1,2-hexanediol, diethylene glycol, triethylene glycol, tetraethylene glycol, dipropylene glycol, tripropylene glycol, polyethylene glycol, polypropylene glycol, 1,8-octanediol, 1,2-octanediol, and 1,9-nonanediol; branched aliphatic glycols such as neopentyl glycol, 3-methyl-1,5-pentanediol, 2-methyl-1,3-propanediol, 2,2-dimethyl-1,3-propanediol, 2-butyl-2-ethyl-1,3-propanediol, 2,2-dibutyl-1,3-propanediol, and 2-methyl-1,8-octanediol; alicyclic glycols such as 1,4-cyclohexanediol, and 1,4-cyclohexane dimethanol; and multifunctional glycols such as glycerin, trimethylolethane, trimethylolpropane, tributylolpropane, pentaerythritol, sorbitol; and the above may be used in isolation, or 2 or more types may be used together, and furthermore, 2 or more types may be used as a copolymer.

### Polyisocyanate

As the polyisocyanate which may be used in an aspect of the invention, a compound containing 2 or more isocyanate groups such as those shown below may be used. Examples thereof include, for example, diethylene diisocyanate, tetramethylene diisocyanate, hexamethylene diisocyanate, trimethyl hexamethylene diisocyanate, cyclohexane diisocyanate, 1,3-bis(isocyanatomethyl) cyclohexane, isophorone diisocyanate, 2,6-bis (isocyanatomethyl)decahydronaphthalene, lysine triisocyanate, 2,4-tolylene diisocyanate, 2,6-tolylene diisocyanate, o-tolidine diisocyanate, 4,4′-diphenylmethane diisocyanate, diphenylether diisocyanate, 3-(2′-cyclohexyl isocyanate)propyl isocyanate, tris(phenyl isocyanate)thiophosphate, isopropylidene-bis(cyclohexyl isocyanate), 2,2′-bis(4-isocyanate-enyl)propane, triphenylmethane triisocyanate, bis(tolyl diisocyanate)phenyl methane, 4,4′,4″-triisocyanate-2,5-dimethoxy-phenylamine, 3,3′-dimethoxy benzidine-4,4′-diisocyanate, 1,3-phenylene diisocyanate, 1,4-phenylene diisocyanate, 4,4′-biphenyl diisocyanato, 4,4′-diisocyanato-3,3′-biphenyl dimethyl, dicyclohexylmethane-4,4′-diisocyanate, 1,1′-methylenebis(4-isocyanatobenzene), 1,1′-methylenebis(3-methyl-4-isocyanatobenzene), m-xylylene diisocyanate, p-xylylene diisocyanate, 1,3-bis(1-isocyanate-1-methylethyl)benzene, 1,4-bis(1-isocyanate-1-methylethyl)benzene, 1,3-bis(2-isocyanato-2-propyl)benzene, 2,6-bis(isocyanatomethyl)tetrahydrodicyclopentadiene, bis(isocyanatomethyl)dicyclopentadiene, bis(isocyanatomethyl)tetrahydrothiophene, bis(isocyanatomethyl)thiophene, 2,5-diisocyanate methyl norbornene, bis(isocyanatomethyl)adamantane, 3,4-diisocyanate selenofan, 2,6-diisocyanate-9-selena bicyclononane, bis(isocyanatomethyl)selenofan, 3,4-diisocyanate, -2,5-diselenoran, dimer acid diisocyanate, 1,3,5-tri(1-isocyanatohexyl)isocyanuric acid, 2,5-diisocyanatomethyl-1,4-dithiane, 2,5-bis(isocyanatomethyl-4-isocyanate-2-thiabutyl)-1,4-dithiane, 2,5-bis(3-isocyanate-2-thiapropyl)-1,4-dithiane, 1,3,5-triisocyanatocyclohexane, 1,3,5-tris(isocyanatomethyl)cyclohexane, bis(isocyanatomethylthio)methane, 1,5-diisocyanate-2-isocyanatomethyl-3-thiapentane, 1,2,3-tris(isocyanatoethylthio)propane, 1,2,3-(isocyanatomethylthio)propane, 1,1,6,6-tetrakis(isocyanatomethyl)-2,5-dithiahexane, 1,1,5,5-tetrakis(isocyanatomethyl)-2,4-dithiapentane, 1,2-bis(isocyanatomethylthio)ethane, 1,5-diisocyanate-3-isocyanatomethyl-2,4-dithiapentane, and the like. Dimers according to a burette reaction of these polyisocyanurates, a cyclized trimer of these polyisocyanates and adducts or the like of polyisocyanates, alcohols or thiols of these. Furthermore, a compound in which part of or all of the isocyanate groups of the above polyisocyanates are changed to isothiocyanate groups may be exemplified. These may be used in isolation or 2 or more types may be used mixed together.

### Organic Acids

As the organic acid which may be used for the acid value introduction of the urethane resin, an organic acid which has carboxylic acid, sulfonic acid, sulfamic acid, silicic acid, metasilic acid, phosphoric acid, metaphosphoric acid, boric acid, thiosulfuric acid, and the like, and has 2 or more hydroxyl groups which can react with isocyanate may be used. In particular, from the viewpoint of reactivity with the multivalent metal ions present in the preprocessing agent for textile printing, organic acids containing carboxyl groups such as dimethylol propionic acid are preferable.

The content of the urethane resin is not particularly limited, however, with respect to the total mass of the ink jet ink, is preferably from 5 to 10 mass %. When the content of the urethane resin exceeds 10 mass %, the ink viscosity increases and in some cases this may impede printability. On the other hand, when the content is less than 5 mass %, there are concerns that the degree of color fastness to rubbing of the printed product will be significantly reduced.

### 1.3. Other Components

In the white ink jet ink for textile printing according to an embodiment of the invention, in addition to the above components, at least 1 type selected from alkanediols and glycol ethers may be added. The alkanediols and glycol ethers increase the wettability to the recording surface of the recording medium or the like, thereby the permeability of the ink may be increased.

As the alkanediols, a 1,2-alkanediol with from 4 to 8 carbon atoms such as 1,2-butanediol, 1,2-pentanediol, 1,2-hexanediol, 1,2-heptanediol, or 1,2-octanediol is preferable. Among these, 1,2-hexanediol, 1,2-heptane diol, and 1,2-octanediol, which have from 6 to 8 carbon atoms, are more preferable due to having a particularly high permeability to the recording medium.

Examples of glycol ethers include, low level alkyl ethers of multivalent alcohols such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. Among these, favorable recording quality may be obtained when using triethylene glycol monobutyl ether.

The content of at least 1 type selected from alkanediols and glycol ethers of these is, with respect to the total mass of the ink jet ink, preferably from 1 to 20 mass %, and more preferably from 3 to 10 mass %.

The white ink jet ink for textile printing according to an embodiment of the invention contains a dispersing agent. As the dispersing agent, for example, anionic polymer dispersing agent, nonionic polymer dispersing agent, anionic surfactant, nonionic surfactant, or the like may be used with no particular limitations. Examples of the anionic polymer dispersing agent include polyacrylic acid, polymethacrylic acid, acrylic acid-acrylonitrile copolymer, vinyl-acrylic acetate acid ester copolymer, acrylic acid-acrylic acid alkyl ester copolymer, styrene-acrylic acid copolymer, styrene-methacrylic acid copolymer, styrene-acrylic acid-acrylic acid alkyl ester copolymer, styrene-methacrylic acid-acrylic acid alkyl ester copolymer, styrene-α-methyl styrene-acrylic acid copolymer, styrene-α-methyl styrene-acrylic acid-acrylic acid alkyl ester copolymer, styrene-maleic acid copolymer, vinylnaphthalene-maleic acid copolymer, vinyl acetate-ethylene copolymer, vinyl acetate-fatty acid vinyl ethylene copolymer, vinyl acetate-maleic acid ester copolymer, vinyl acetate-crotonic acid copolymer, vinyl acetate-acrylic acid copolymer, and the like. Examples of the nonionic polymer dispersing agent include polyvinylpyrrolidone, polypropylene glycol, vinylpyrrolidone-vinyl acetate copolymer, and the like. Examples of the anionic surfactant include sodium dodecylbenzenesulphonate, sodium lacrylate, polyoxyethylene alkyl ether sulfate ammonium salt, and the like. Examples of the nonionic surfactant include polyoxyethylene alkyl ether, polyoxyethylene alkyl ester, polyoxyethylene sorbitan fatty acid ester, polyoxyethylene alkyl phenyl ether, polyoxyethylene alkyl amine, polyoxyethylene alkyl amide, and the like. Among these, from the viewpoint of increasing the dispersion stability of the pigment, an anionic polymer dispersing agent is preferable, and using a styrene-acrylic acid copolymer is particularly preferable.

It is preferable that the content of the dispersing agent be, with respect to the content of the white pigment, from 3 to 30 mass %. By setting the content of the dispersing agent and the white pigment to the above range, an ink having excellent white pigment dispersion properties may be obtained, and an ink having excellent redispersibility even if the white pigment has aggregated may be obtained.

In the ink jet ink according to an aspect of the present embodiment, in addition to the above components, an acetylene glycol surfactant or a polysiloxane surfactant may be added. The acetylene glycol surfactant or the polysiloxane surfactant increase the wettability to the recording surface of the recording medium or the like, thereby the permeability of the ink may be increased.

Examples of acetylene glycol surfactant include 2,4,7,9-tetramethyl-5-decyne-4,7-diol, 3,6-dimethyl-4-octyne-3,6-diol, 3,5-dimethyl-1-hexyne-3-ol, 2,4-dimethyl-5-hexyne-3-ol, or the like. In addition, examples of the acetylenic glycol surfactant include a commercial product, for example, Olefin (registered trademark) E1010, STG, or Y (manufactured by Nissin Chemical Industry Co., Ltd.), Surfynol (registered trademark) 104, 104PG50, 82, 465, 485, or TG (manufactured by Air Products and Chemicals Inc.).

Examples of the polysiloxane surfactant include a commercial product, for example, BYK-347 or BYK-348 (manufactured by BYK Japan KK) and the like.

Furthermore, in the ink jet ink according to an aspect of the present embodiment, other surfactants such as anionic surfactants, nonionic surfactants, and amphoteric surfactants may be added.

The content of the surfactant is, with respect to the total mass of the ink jet ink, preferably from 0.01 to 5 mass %, and more preferably is from 0.1 to 0.5 mass %.

In the ink jet ink according to an aspect of the present embodiment, in addition to the above components, a multivalent alcohol may be added. The multivalent alcohol may prevent drying of the ink, and may prevent clogging of the ink in the ink jet recording head unit.

Examples of the multivalent alcohol include ethylene glycol, diethylene glycol, triethylene glycol, polyethylene glycol, polypropylene glycol, propylene glycol, butylene glycol, 1,2,6-hexane triol, thioglycol, hexylene glycol, glycerin, trimethylol ethane, trimethylol propane.

The content of the multivalent alcohol is, with respect to the total mass of the ink jet ink, preferably from 0.1 to 30 mass %, and more preferably is from 0.5 to 20 mass %.

The ink jet ink according to the present embodiment may also be a so-called aqueous ink containing 50 mass % or more of water. In a water-based ink, in comparison to a nonaqueous (solvent) ink, the reactivity with the piezo elements used in the recording head or the organic binder and the like contained in the recording medium is weak, thereby there are few defects such as melting and corrosion. In addition, in a nonaqueous (solvent) ink, when the solvent used has a high boiling point and a low viscosity, a problem of drying taking an extremely long time also occurs. Furthermore, in comparison with a solvent ink, a water-based ink has the merits of the smell thereof being extremely suppressed, and being good for the environment due to being half or more water. Furthermore, examples of the water include ion-exchanged water, reverse osmosis water, distilled water, ultrapure water, and the like, and it is preferable that the content of the water be from 50 to 90 mass %.

The ink jet ink according to the present embodiment may be prepared in the same manner as a pigment ink of the related art by using, for example, a ball mill, a sand mill, an attritor, a basket mill, a roll mill, or the like. When performing preparation, it is preferable to remove coarse particles using a membrane filter, a mesh filter, or the like.

### 3. Examples

Below, the invention will be described in further detail using examples, but the content of the invention is not limited by these.

### Example A

### 3.1 Preparation of White Ink Composition

Each ink was prepared by mixing each component according to the compositions of Table 1 and Table 2 below. For each ink, white pigment dispersion liquid, pigment dispersion resin, urethane resin, organic solvent, multivalent alcohol, surfactant, and ion-exchanged water were mixed and stirred, filtered in a metal filter having a hole diameter of 5 μm, and evacuation processing was performed using a vacuum pump to obtain each of the white ink compositions of Examples A1 to A7 and Comparative Examples A1 to A5. The unit of concentration disclosed in the table is mass %, and with respect to the white pigment dispersion liquid, the pigment dispersion resin, and the urethane resin, is solid component concentration.

As the white pigment dispersion liquid, the commercial product “NanoTek (R) Slurry” (manufactured by C. I. Kasei Co., Ltd.) was used. NanoTek (R) Slurry is a slurry containing titanium dioxide particles of an average particle diameter of 360 nm at a ratio of a 15% solid component concentration.

As the surfactant, Surfynol 104, and Surfynol 465, which are acetylene glycol surfactants (manufactured by Air Products and Chemicals Inc.) were used.

As the pigment dispersion resin, the styrene acryl resin “YS-1274” (manufactured by Seiko PMC CORP.) was used.

As the urethane resin, urethane resins A1 to A11 which have different average particle diameters were used. Furthermore, urethane resins A1, A2, A6, A7, A9 and A10 were synthesized using an established method. As the urethane resins A3, A4, A5, A8, and A11, respectively, Superflex 460, 470, 150, 420, and 740 (all manufactured by Dai-Ichi Kogyo Seiyaku Co., Ltd.) were used.

TABLE 1

| | | Example A1 | Example A2 | Example A3 | Example A4 | Example A5 | Example A6 | Example A7 |
|---|---|---|---|---|---|---|---|---|
| White Ink | White pigment dispersion liquid | 10% | 10% | 10% | 10% | 10% | 10% | 10% |
| Composition | Pigment dispersion resin | 0.5% | 0.5% | 0.5% | 0.5% | 0.5% | 0.5% | 0.5% |
| | YS-1274 | | | | | | | |
| | Urethane resin A1 | 5% | — | — | — | — | — | — |
| | Urethane resin A2 | — | 5% | — | — | — | — | — |
| | Urethane resin A3 (SF460) | — | — | 5% | — | — | — | — |
| | Urethane resin A4 (SF470) | — | — | — | 5% | — | — | — |
| | Urethane resin A5 (SF150) | — | — | — | — | 5% | — | — |
| | Urethane resin A6 | — | — | — | — | — | 5% | — |
| | Urethane resin A7 | — | — | — | — | — | — | 5% |
| | 1,2-Hexanediole | 0.5% | 0.5% | 0.5% | 0.5% | 0.5% | 0.5% | 0.5% |
| | Butyltriglycol | 1.5% | 1.5% | 1.5% | 1.5% | 1.5% | 1.5% | 1.5% |
| | Surfynol-104 | 0.3% | 0.3% | 0.3% | 0.3% | 0.3% | 0.3% | 0.3% |
| | Surfynol-465 | 0.5% | 0.5% | 0.5% | 0.5% | 0.5% | 0.5% | 0.5% |
| | Glycerin | 5.0% | 5.0% | 5.0% | 5.0% | 5.0% | 5.0% | 5.0% |
| | Trimethylolpropane | 3.0% | 3.0% | 3.0% | 3.0% | 3.0% | 3.0% | 3.0% |
| | Triethylene glycol | 4.0% | 4.0% | 4.0% | 4.0% | 4.0% | 4.0% | 4.0% |
| | Triethanolamine | 1.0% | 1.0% | 1.0% | 1.0% | 1.0% | 1.0% | 1.0% |
| | Ion-exchanged water | Residual | Residual | Residual | Residual | Residual | Residual | Residual |
| | | quantity | quantity | quantity | quantity | quantity | quantity | quantity |
| | Total | 100% | 100% | 100% | 100% | 100% | 100% | 100% |
| Physical | Urethane resin particle | 30 | 30 | 30 | 50 | 70 | 120 | 150 |
| Properties of | diameter/nm | | | | | | | |
| Urethane Resin | Ionicity | Anion | Anion | Anion | Anion | Anion | Anion | Anion |
| Average Particle Diameter of White Pigment/ | | 12 | 12 | 12 | 7.2 | 5.1 | 3 | 2.4 |
| Average Particle Diameter of Urethane Resin | | | | | | | | |
| Evaluation of | Redispersibility | A | A | B | A | A | A | A |
| White Ink | Color Fastness to Rubbing | A | A | A | A | A | A | A |

TABLE 2

| | | Comparative | Comparative | Comparative | Comparative | Comparative |
|---|---|---|---|---|---|---|
| | | Example A1 | Example A2 | Example A3 | Example A4 | Example A5 |
| White Ink | White pigment dispersion liquid | 10% | 10% | 10% | 10% | 10% |
| Composition | Pigment dispersion resin | 0.5% | 0.5% | 0.5% | 0.5% | 0.5% |
| | YS-1274 | | | | | |
| | Urethane resin A8 (SF420) | 5% | — | — | — | — |
| | Urethane resin A9 | — | 5% | — | — | — |
| | Urethane resin A10 | — | — | 5% | — | — |
| | Urethane resin A11 (SF740) | — | — | — | 5% | — |
| | 1,2-Hexanediole | 0.5% | 0.5% | 0.5% | 0.5% | 0.5% |
| | Butyltriglycol | 1.5% | 1.5% | 1.5% | 1.5% | 1.5% |
| | Surfynol-104 | 0.3% | 0.3% | 0.3% | 0.3% | 0.3% |
| | Surfynol-465 | 0.5% | 0.5% | 0.5% | 0.5% | 0.5% |
| | Glycerin | 5.0% | 5.0% | 5.0% | 5.0% | 5.0% |
| | Trimethylolpropane | 3.0% | 3.0% | 3.0% | 3.0% | 3.0% |
| | Triethylene glycol | 4.0% | 4.0% | 4.0% | 4.0% | 4.0% |
| | Triethanolamine | 1.0% | 1.0% | 1.0% | 1.0% | 1.0% |
| | Ion-exchanged water | Residual quantity | Residual quantity | Residual quantity | Residual quantity | Residual quantity |
| | Total | 100% | 100% | 100% | 100% | 100% |
| Physical Properties | Urethane resin particle | 10 | 20 | 20 | 200 | — |
| of Urethane Resin | diameter/nm | | | | | |
| | Ionicity | Anion | Anion | Anion | Anion | — |
| Average Particle Diameter of White Pigment/ | | 36 | 18 | 18 | 1.8 | — |
| Average Particle Diameter of Urethane Resin | | | | | | |
| Evaluation of White | Redispersibility | C | C | C | C | A |
| Ink | Color Fastness to Rubbing | A | A | A | A | C |

### 3.2. Redispersibility Evaluation

In regard to each of the inks of Examples A1 to A7 and Comparative Examples A1 to A5, evaluation of the redispersibility was performed. First, each ink is added 100 mL at a time to a 100 mL screw-top bottle manufactured by AS ONE Corp., then hermetically sealed, and storage was performed for half a year in an environment of 25° C., 50% RH. Subsequently, after shaking them up and down 10 times reciprocally over a distance of 30 cm, 1 g of the ink within the screw-top bottle was sampled, and dilution was performed using distilled water so as to become 1000 times the standard volume. In regard to the obtained diluted liquid, using a spectrophotometer (product name “Spectrophotometer U-3300” manufactured by Hitachi Ltd.), the absorbance (Abs−b) at a wavelength of 500 nm of the diluted liquid was measured.

In addition, with respect to each of the inks of Examples A1 to A7 and Comparative Examples A1 to A5, as well as making the inks into diluted liquids straight after preparation, the absorbance (ABs−a) at a wavelength of 500 nm of the diluted liquid was measured in the same manner as above.

As an index of evaluation of the redispersibility, the recovery factor of the absorbance was calculated using the Formula (2) below.

Recovery factor of absorbance (%)=100×(Abs−b)/(Abs−a) (2)

The obtained results were evaluated using the following standard.
A: Recovery factor is 90% or more
B: Recovery factor is 80% or more, and less than 90%
C: Recovery factor is 70% or more, and less than 80%
D: Recovery factor is less than 70%

### 3.3. Evaluation of Color Fastness to Rubbing

On the whole surface of a 100% cotton black broad cloth (210 mm×297 mm), the preprocessing agent “White Base Base Coat for MMP-813BT-T” manufactured by Mastermind Co., Ltd. was evenly coated using a sprayer. After the coating, the black broad cloth was heat processed for 2 minutes at 160° C., and the preprocessing of the fabric was performed.

The ink of Examples A1 to A7 and Comparative Examples A1 to A5 was introduced to the textile printer “MMP813BT” manufactured by Mastermind Co., Ltd. and solid printing of 1440 dpi×1440 dpi, 120 mm×120 mm was performed with respect to the preprocessed fabric. After that, heat processing was performed for 5 minutes at 160° C., thereby the printed product was manufactured.

The color fastness to rubbing test of the printed product was performed using the AB-301 Color Fastness Rubbing Tester (manufactured by Tester Sangyo Ltd.) based on a JISL0849 Type II Color Fastness Rubbing Tester (100 reciprocations with a load of 200 g). Furthermore, for the abrading cloth, the black broad cloth used for printing of the white ink was used. The evaluation of the color fastness to rubbing test was performed by measuring the reflectance of light when the printed product before and after the rubbing test was irradiated by light with a wavelength of 457 nm using the Gretag Macbeth™ SPM50 (30 color measurement points), and evaluation was performed according to the rate of decrease in degree of whiteness calculated from Formula (3) below.

Rate of decrease in degree of whiteness (%)=100−(reflectance after test)/(reflectance before test)×100 (3)

The evaluation standard of the obtained results are as follows.

The obtained results were evaluated using the following standard.
A: Rate of decrease in degree of whiteness is less than 10%
B: Rate of decrease in degree of whiteness is 10% or more and less than 15%
C: Rate of decrease in degree of whiteness is 15% or more and below 20%
D: Rate of decrease in degree of whiteness is 20% or more

### 4. Evaluation Result

### 4.1. Results of Redispersibility Evaluation

Table 1 shows the results of the redispersibility evaluation. From the results of Table 1, when the value of the average particle diameter of the white pigment/the average particle diameter of the urethane resin is from 2 to 12, the redispersibility is favorable.

### 4.2. Results of Color Fastness to Rubbing

Table 1 shows the results of the color fastness to rubbing evaluation. Accordingly, it can be understood that favorable results may be obtained by adding a urethane resin.

### Example B

### 5.1. Preparation of White Ink Composition

Each ink was prepared by mixing each component according to the compositions of Table 3 and Table 4 below. For each ink, white pigment dispersion liquid, pigment dispersion resin, urethane resin, organic solvent, multivalent alcohol, surfactant, and ion-exchanged water were mixed and stirred, filtered in a metal filter having a hole diameter of 5 μm, and evacuation processing was performed using a vacuum pump to obtain each of the white ink compositions of Examples B1 to B4 and Comparative Examples B1 to B5. The unit of concentration disclosed in the table is mass %, and with respect to the white pigment dispersion liquid, the pigment dispersion resin, and the urethane resin, is solid component concentration.

As the white pigment dispersion liquid, the commercial product “NanoTek (R) Slurry” (manufactured by C. I. Kasei Co., Ltd.) was used. NanoTek (R) Slurry is a slurry containing titanium dioxide particles of an average particle diameter of 360 nm at a ratio of a 15% solid component concentration.

As the surfactant, Surfynol 104, and Surfynol 465 which are acetylene glycol surfactants (manufactured by Air Products and Chemicals Inc.) were used.

As the pigment dispersion resin, the styrene acryl resin “YS-1274” (manufactured by Seiko PMC CORP.) was used.

As the urethane resin, urethane resins B1 to B9 which have different acid values (mgKOH/g) were used. Furthermore, urethane resins B1, B2, and B9 were synthesized using an established method. As the urethane resins B3, B4, B5, B6, B7 and B8, respectively, Superflex 470, 150, 740, 800, 870, and 210 (all manufactured by Dai-Ichi Kogyo Sseiyaku Co., Ltd.) were used.

TABLE 3

| | | Example B1 | Example B2 | Example B3 | Example B4 |
|---|---|---|---|---|---|
| White Ink | White pigment dispersion liquid | 10% | 10% | 10% | 10% |
| Composition | Urethane resin B1 (acid value 20) | 5% | — | — | — |
| | Urethane resin B2 (acid value 20) | — | 5% | — | — |
| | Urethane resin B3 (acid value 12, SF470) | — | — | 10% | — |
| | Urethane resin B4 (acid value 17, SF150) | — | — | — | 5% |
| | 1,2-Hexanediole | 0.5% | 0.5% | 0.5% | 0.5% |
| | Butyltriglycol | 1.5% | 1.5% | 1.5% | 1.5% |
| | Surfynol-104 | 0.3% | 0.3% | 0.3% | 0.3% |
| | Surfynol-465 | 0.5% | 0.5% | 0.5% | 0.5% |
| | Glycerin | 5.0% | 5.0% | 5.0% | 5.0% |
| | Trimethylolpropane | 3.0% | 3.0% | 3.0% | 3.0% |
| | Triethylene glycol | 4.0% | 4.0% | 4.0% | 4.0% |
| | Triethanolamine | 1.0% | 1.0% | 1.0% | 1.0% |
| | Ion-exchanged water | Residual | Residual | Residual | Residual |
| | | quantity | quantity | quantity | quantity |
| | Total | 100% | 100% | 100% | 100% |
| Physical | Urethane resin particle diameter/nm | 30 | 30 | 50 | 70 |
| Properties of | Ionicity | Anion | Anion | Anion | Anion |
| Urethane Resin | | | | | |
| Average Particle Diameter of White Pigment/Average Particle | | 12 | 12 | 7.2 | 5.1 |
| Diameter of Urethane Resin | | | | | |
| Evaluation of | Redispersibility | A | A | B | B |
| White Ink | Color fastness to rubbing | A | A | A | A |
| | Degree of whiteness (front surface) | A | A | A | A |
| | Degree of whiteness (rear surface) | A | A | B | B |

TABLE 4

| | | Comparative | Comparative | Comparative | Comparative | Comparative |
|---|---|---|---|---|---|---|
| | | Example B1 | Example B2 | Example B3 | Example B4 | Example B5 |
| White Ink | White pigment dispersion liquid | 10% | 10% | 10% | 10% | 10% |
| Composition | Urethane resin B5 (acid value | 10% | — | — | — | — |
| | 8, SF740) | | | | | |
| | Urethane resin B6 (acid value | — | 10% | — | — | — |
| | 27, SF800) | | | | | |
| | Urethane resin B7 (acid value | — | — | 10% | — | — |
| | 27, SF870) | | | | | |
| | Urethane resin B8 (acid value | — | — | — | 10% | — |
| | 42, SF210) | | | | | |
| | Urethane resin B9 (acid value | — | — | — | — | 5% |
| | 25) | | | | | |
| | 1,2-Hexanediole | 0.5% | 0.5% | 0.5% | 0.5% | 0.5% |
| | Butyltriglycole | 1.5% | 1.5% | 1.5% | 1.5% | 1.5% |
| | Surfynol-104 | 0.3% | 0.3% | 0.3% | 0.3% | 0.3% |
| | Surfynol-465 | 0.5% | 0.5% | 0.5% | 0.5% | 0.5% |
| | Glycerin | 5.0% | 5.0% | 5.0% | 5.0% | 5.0% |
| | Trimethylolpropane | 3.0% | 3.0% | 3.0% | 3.0% | 3.0% |
| | Triethylene glycol | 4.0% | 4.0% | 4.0% | 4.0% | 4.0% |
| | Triethanolamine | 1.0% | 1.0% | 1.0% | 1.0% | 1.0% |
| | Ion-exchanged water | Residual quantity | Residual quantity | Residual quantity | Residual quantity | Residual quantity |
| | Total | 100% | 100% | 100% | 100% | 100% |
| Physical Properties | Urethane resin particle | 200 | 30 | 30 | 50 | 20 |
| of Urethane Resin | diameter/nm | | | | | |
| | Ionicity | Anion | Anion | Anion | Anion | Anion |
| Average Particle Diameter of White Pigment/ | | 1.8 | 12 | 12 | 7.2 | 18 |
| Average Particle Diameter of Urethane Resin | | | | | | |
| Evaluation of White | Redispersibility | C | B | B | B | C |
| Ink | Color fastness to rubbing | E | B | B | C | A |
| | Degree of whiteness (front | D | C | C | C | A |
| | surface) | | | | | |
| | Degree of whiteness (rear | D | A | A | A | A |
| | surface) | | | | | |

### 5.2. Redispersibility Evaluation

In regard to each of the inks of Examples B1 to B4 and Comparative Examples B1 to B5, evaluation of the redispersibility was performed. First, each ink is added 100 mL at a time to a 100 mL screw-top bottle (manufactured by AS ONE Corp.), then hermetically sealed, and storage was performed for half a year in an environment of 25° C., 50% RH. Subsequently, after shaking them up and down 10 times reciprocally over a distance of 30 cm, 1 g of the ink within the screw-top bottle was sampled, and dilution was performed using distilled water so as to become 1000 times the standard volume. In regard to the obtained diluted liquid, using a spectrophotometer (product name “Spectrophotometer U-3300” manufactured by Hitachi Ltd.), the absorbance (Abs−b) at a wavelength of 500 nm of the diluted liquid was measured.

In addition, with respect to each of the inks of Examples B1 to B4 and Comparative Examples B1 to B5, as well as making the inks into diluted liquids straight after preparation, the absorbance (ABs−a) at a wavelength of 500 nm of the diluted liquid was measured in the same manner as above.

As an index of evaluation of the redispersibility, the recovery factor of the absorbance was calculated using the Formula (2) below.

Recovery factor of absorbance (%)=100×(Abs−b)/(Abs−a) (2)

The obtained results were evaluated using the following standard.
A: Recovery factor is 90% or more
B: Recovery factor is 80% or more, and less than 90%
C: Recovery factor is 70% or more, and less than 80%
D: Recovery factor is less than 70%

### 5.3. Evaluation of Color Fastness to Rubbing

On the whole surface of a 100% cotton black broad cloth (210 mm×297 mm), the preprocessing agent “White Base Base Coat for MMP-813BT-T” manufactured by Mastermind Co., Ltd. was evenly coated using a sprayer. After the coating, the black broad cloth was heat processed for 2 minutes at 160° C., and the preprocessing of the fabric was performed.

The ink of Examples B1 to B4 and Comparative Examples B1 to B5 was introduced to the textile printer “MMP813BT” manufactured by Mastermind Co., Ltd. and solid printing of 1440 dpi×1440 dpi, 120 mm×120 mm was performed with respect to the preprocessed fabric. After that, heat processing was performed for 5 minutes at 160° C., thereby the printed product was manufactured.

The color fastness to rubbing test of the printed product was performed using the AB-301 Color Fastness Rubbing Tester (manufactured by Tester Sangyo, Ltd.) based on a JISL0849 Type II Color Fastness Rubbing Tester (100 reciprocations with a load of 200 g). Furthermore, for the abrading cloth, the black broad cloth used for printing of the white ink was used. The evaluation of the color fastness to rubbing test was performed by measuring the reflectance of light when the printed product before and after the rubbing test was irradiated by light with a wavelength of 457 nm using the Gretag Macbeth™ SPM50 (30 color measurement points), and evaluation was performed according to the rate of decrease in degree of whiteness calculated from Formula (3) below.

Rate of decrease in degree of whiteness (%)=100−(reflectance after test)/(reflectance before test)×100 (3)

The evaluation standard of the obtained results are as follows.
A: Rate of decrease in degree of whiteness is less than 10%
B: Rate of decrease in degree of whiteness is 10% or more and less than 15%
C: Rate of decrease in degree of whiteness is 15% or more and below 20%
D: Rate of decrease in degree of whiteness is 20% or more
E: Impossible to Evaluate

### 5.4. Degree of Whiteness Evaluation

Measurement of the reflectance of light when the printed product was irradiated by light with a wavelength of 457 nm using the Gretag Macbeth™ SPM50 was performed at 30 points, and evaluation was performed using the calculated average value.

The evaluation standard of the obtained results are as follows.

### Degree of Whiteness of Front Surface

A: Reflectance is 0.77 or more
B: Reflectance is 0.7 or more and less than 0.77
C: Reflectance is 0.6 or more and less than 0.7
D: Reflectance is less than 0.6

### Degree of Whiteness of Rear Surface

A: Reflectance is less than 0.005
B: Reflectance is 0.005 or more and less than 0.015
C: Reflectance is 0.015 or more and less than 0.025
D: Reflectance is 0.025 or more

### 6. Evaluation Result

### 6.1. Results of Redispersibility Evaluation

Table 3 shows the results of the redispersibility evaluation. From the results of Table 1, when the value of the average particle diameter of the white pigment/the average particle diameter of the urethane resin is from 2 to 12, the redispersibility are favorable.

### 6.2. Results of Color Fastness to Rubbing

Table 3 shows the results of the color fastness to rubbing evaluation. Accordingly, it can be understood that favorable results may be obtained by adding a urethane resin.

### 6.3. Results of Degree of Whiteness

Table 3 shows the evaluation results of the degree of whiteness. Accordingly, it can be understood that when the value of the average particle diameter of the white pigment/the average particle diameter of the urethane resin is from 2 to 12 and the acid value of the urethane resin is from 10 to 25 mgKOH/g, favorable color development having excellent redispersibility and no strike through may be realized.

The invention is not limited to the embodiments described above, and various modifications thereof are possible. For example, the invention includes configurations which are the substantially the same as the configurations described in the embodiments (for example, configurations having the same function, method and results, or configurations having the same purpose and effect). In addition, the invention includes configurations to which non-essential parts of the configurations described in the embodiments are replaced. In addition, the invention includes configurations exhibiting the same operation and effect as the configurations described in the embodiments or configurations capable of achieving the same purpose. In addition, the invention includes configurations in which known techniques were added to the configurations described in the embodiments.

What is claimed is:

1. A white ink jet ink for textile printing comprising:
a white pigment; and
a urethane resin,
wherein an average particle diameter of the white pigment and an average particle diameter of the urethane resin satisfy the following formula:
2≦average particle diameter of white pigment/average particle diameter of urethane resin≦12.

2. The white ink jet ink for textile printing according to claim 1,
wherein the white pigment is titanium dioxide of an average particle diameter of from 300 nm to 400 nm, and a content of the titanium dioxide with respect to a total mass of ink is from 5 to 15 mass %.

3. The white ink jet ink for textile printing according to claim 1,
wherein the urethane resin has an acid value of from 10 to 25 mgKOH/g.

4. The white ink jet ink for textile printing according to claim 1,
wherein a content of the urethane resin with respect to a total mass of ink is from 5 to 10 mass %.

5. The white ink jet ink for textile printing according to claim 1, further comprising:
a dispersion resin,
wherein a mass ratio of a content of the dispersion resin with respect to a mass of a content of the white pigment is from 3 to 30 mass %.

6. The white ink jet ink for textile printing according to claim 1,
wherein a moisture content of a total mass of ink is from 50 to 90 mass %.
